(19) United States
(12) Patent Application Publication
(10) Pub. No.: US 2008/0122221 A1
(43) Pub. Date: May 29, 2008

(54) Aircraft fuel pipe coupling

(75) Inventor: Robert James Bridgewater, Filton (GB)

Correspondence Address: NIXON & VANDERHYE, PC, 901 NORTH GLEBE ROAD, 11TH FLOOR, ARLINGTON, VA, 22203, US

(73) Assignee: AIRBUS UK LIMITED, Bristol (GB)

(21) Appl. No.: 11/979,677

(22) Filed: Nov. 7, 2007

(30) Foreign Application Priority Data
Nov. 24, 2006 (GB) 0623480.1

(51) Int. Cl. F16L 27/00

(52) U.S. Cl. 285/184

(57) ABSTRACT

The invention relates to a fuel pipe coupling (101), in particular a fuel pipe coupling for an aircraft. The invention provides a pipe end fitting (102) including a flange (103), a resiliently deformable interfacing body (105) including a partially spherical internal surface (112) and a socket arrangement (104). The coupling is arranged such that the flange (103) of the pipe end fitting (102) is associated with the partially spherical internal surface (112) of the resiliently deformable interfacing body (105) and may move both axially and angularly with respect to the socket arrangement (104).

### TECHNICAL FIELD

This invention relates to fuel pipe couplings, particularly, but not exclusively, to partially spherical aircraft fuel pipe couplings.

### BACKGROUND OF THE INVENTION

Aircraft fuel systems require large networks of pipes throughout the infrastructure of an aircraft in order to transport the fuel from the fuel tanks, which may be in the body and/or wings of the aircraft, to the engine or engines of the aircraft. There may be pipes arranged between the ribs of the aircraft wing. Couplings may be required to join different sections of pipe. For example, pipes may be connected to fixed couplings that pass through the ribs. The couplings need to be able to accommodate some angular and axial movement of the fuel pipes which, for example, may occur as the result of wing flexure and/or vibration. Present aircraft fuel pipe couplings may allow a restricted amount of movement, approximately ±2 degrees at most. Also, as a result of the design of such fuel pipe couplings, the metal parts of the coupling can be subject to wear as a result of such movement. Such wear, if prolonged, can result in leaks.

The fuel pipe couplings may be used when a fuel line passes through an aircraft rib, joining a pipe on one side of the rib to a pipe on the other side of the rib. The angle at which the two pipes meet may vary considerably. Therefore, each coupling has to be individually produced for use in a particular join in an aircraft, greatly increasing the cost of the couplings. It is desirable to reduce the number of different fuel pipe couplings used throughout an aircraft in order to reduce manufacturing and assembly costs and complexity.

The present invention seeks to mitigate or overcome one or more of the above-identified disadvantages.

### SUMMARY OF THE INVENTION

The present invention provides an aircraft fuel pipe coupling comprising,

a pipe end fitting including a flange,

a socket arrangement in which the pipe end fitting is located,

a resiliently deformable interfacing body including a partially spherical internal surface,

the resiliently deformable interfacing body located between the pipe end fitting and the socket arrangement such that the partially spherical internal surface is associated with the flange of the pipe end fitting,

a first seal located between the partially spherical internal surface of the of the resiliently deformable interfacing body and the flange of the pipe end fitting, and

a second seal located between the resiliently deformable interfacing body and the socket arrangement.

Embodiments of the present invention may thus advantageously provide a universal pipe coupling able to be used in a wide variety of different applications in aircraft fuel pipe systems, for joining pipe sections that meet at a variety of different angles. Alternatively, or additionally, the fuel pipe coupling of embodiments of the present invention may advantageously be in the form of a coupling able to provide both axial and significant angular movement of one pipe section relative to another pipe section, the sections being connected via the coupling.

Preferably, the resiliently deformable interfacing body is formed of a single piece of resiliently deformable material. This has the benefit of reducing sealing problems associated with an interfacing body that comprises more than one piece of material joined together.

The flange of the pipe end fitting associated with the resiliently deformable interfacing body may be partially spherical. The partially spherical part of the flange may for example engage with the partially spherical internal surface of the interfacing body. It will be understood that the flange may have any suitable shape for engagement with the resiliently deformable interfacing body, and may be relatively wide in the axial direction.

Preferably, the pipe end fitting may move angularly relative to the socket arrangement. The angular movement may be as a result of the flange of the pipe end fitting rotating within the partially spherical internal surface of the resiliently deformable interfacing body. The angular movement of the pipe end fitting relative to the socket may be about an axis substantially parallel to the axis of the pipe end fitting and/or the socket. The angular movement of the pipe end fitting relative to the socket may be about an axis transverse to the longitudinal axis of the pipe end fitting or transverse to the longitudinal axis of the socket (and preferably transverse to both). For example, the angular movement may be rotational movement about an axis that is at an angle of 60 degrees to the axis of the pipe end fitting. Preferably, the pipe end fitting may move angularly relative to the socket arrangement about any of three orthogonal axes. The pipe end fitting may be capable of ±10 degrees of angular movement relative to the socket arrangement.

The pipe end fitting may be capable of axial movement with respect to the socket arrangement. The size of the socket arrangement may determine the amount of axial movement available. The pipe end fitting may be capable of axial movement relative to the socket arrangement of ±9 mm, and may be capable of axial movement of ±18 mm.

The resiliently deformable interfacing body may be made from the same material as that of one of the seals. In such a case, the seals may be integrally formed as part of the interfacing body. Preferably however the seals are separate from the interfacing body. The resiliently deformable interfacing body may be made of material less deformable than the first seal. The resiliently deformable interfacing body may be made of material less deformable than the second seal. The resiliently deformable interfacing body being less deformable than the first and/or second seal may assist the formation of a good sealing contact between the resiliently deformable interfacing body and the said seal or seals. The resiliently deformable interfacing body may carry at least one of the seals. The resiliently deformable interfacing body may carry two, or more, seals. Alternatively, the resiliently deformable interfacing body may carry none of the seals. At least one of the seals may be carried in a Gamah profile seal carrier.

The resiliently deformable interfacing body is preferably sufficiently deformable and so shaped to allow the fuel pipe coupling to be manufactured by means of a method of manufacture including forcing the flange of the pipe end fitting into the body.

The present invention also provides, in accordance with another aspect of the invention, an aircraft fuel pipe coupling comprising, a pipe end (for example in the form of a pipe end fitting), a socket arrangement in which the pipe end is located, and an interfacing body (preferably a resiliently deformable interfacing body) including a partially spherical internal surface, the interfacing body being located between the pipe end and the socket arrangement such that the partially spherical internal surface is associated with a part of the exterior surface of the pipe end (for example a flange defined by a pipe end fitting). The aircraft fuel pipe coupling may thereby be arranged to facilitate both axial translational movement and angular movement (about a transverse axis) between the pipe end and the socket arrangement. Features of the pipe coupling according to this aspect of the invention may be incorporated into the pipe coupling according to the previously described aspect of the invention and vice versa.

The invention further provides an aircraft fuel pipe system, including a first aircraft fuel pipe coupling in accordance with the coupling described above and a second aircraft fuel pipe coupling in accordance with the coupling described above, wherein the first and second pipe end fittings of the couplings form the opposite ends of a fuel pipe, the fuel pipe extending between the first socket arrangement and second socket arrangement.

The fuel pipe may be trapped between the first and second aircraft fuel pipe couplings in a floating manner, such that it may move relative to each coupling. Preferably, the fuel pipe is fully floating between the first and second aircraft fuel pipe coupling, meaning that no other retaining means is required to keep the fuel pipe in place other than the physical dimensions of the fuel pipe system. The pipe end fitting may be integrally formed with the fuel pipe.

The invention also provides an aircraft fuel pipe system, including an aircraft fuel pipe coupling as described above, further including a first fuel pipe connected to the pipe end fitting and a second fuel pipe connected to the socket arrangement.

The relatively large angular variation possible between the pipe end fitting and the socket makes it possible for similar aircraft fuel pipe couplings to be used in different positions across the aircraft, even though different pipe connections are formed by pipes meeting over a range of different angles depending on the location of the pipes. Standardisation of the fuel pipe couplings may results in simplified manufacturing processes and the resultant cost savings.

The invention further provides a method of connecting aircraft fuel pipes by means of an aircraft fuel pipe coupling according to the invention as described herein.

The invention also provides a method of connecting aircraft fuel pipes, the method comprising the steps of:

providing a pipe end fitting including a flange,

providing a deformable interfacing body including a partially spherical internal surface,

manipulating the resiliently deformable interfacing body over the pipe end fitting such that the partially spherical internal surface is associated with the flange of the pipe end fitting and such that a seal is formed between the flange of the pipe end fitting and the resiliently deformable interfacing body,

providing a socket arrangement, and

locating the pipe end fitting and resiliently deformable interfacing body in the socket arrangement such that a seal is formed between the resiliently deformable interfacing body and the socket arrangement.

The method may thus facilitate a connection between a first pipe associated with the pipe end fitting and a second pipe associated with the socket arrangement. The steps of the method are preferably, but need not be, performed in the order set forth above. The method may further comprise the step of transferring fuel through the aircraft fuel pipes. The method may be performed by means of using a fuel pipe coupling or kit of parts therefor according to the invention as described herein.

The formation of the seal between the flange of the pipe end fitting and the resiliently deformable interfacing body may involve using a separate seal, such as an O-ring for example. Similarly, the formation of the seal between the resiliently deformable interfacing body and the socket arrangement may involve using a separate seal, such as an O-ring for example.

The method may provide a flexible connection between first and second pipes, allowing both axial and angular movement between the first and second pipes. The method may for example further include a step of effecting relative movement between the pipe end fitting and the socket arrangement of a distance of more than 9 mm, more preferably more than 18 mm, as measured along the axis of the pipe end fitting. The method may additionally or alternatively include a step of effecting relative rotational movement between the pipe end fitting and the socket arrangement of a distance of more than 5 degrees, and more preferably more than about 10 degrees, about an axis transverse to the axis of the pipe end fitting.

The invention further provides an aircraft, the aircraft including a fuel pipe coupling or fuel pipe system as described above.

The invention may further provide a kit of parts, the kit of parts comprising a pipe end fitting, a socket arrangement, a resiliently deformable interfacing body, suitable for arrangement such that a fuel pipe coupling as described above may be assembled. The kit may be used to retrofit existing aircraft with the fuel pipe coupling, either in the course of routine maintenance or as a result of replacing defective couplings. The kit may include one or more seals.

It will of course be appreciated that features of one aspect of the invention may be incorporated into other aspects of the invention. For example, the parts of the kit of parts of the present invention may incorporate features described with reference to the fuel pipe coupling of the invention. Also, the method may be performed with the use of the kit of parts and/or the method may result in producing a fuel pipe coupling according to the present invention.

### BRIEF DESCRIPTION OF THE DRAWINGS

Embodiments of the fuel pipe coupling of the invention will now be described, by way of example only, with reference to the accompanying drawings of which:

FIG. 1 shows a fuel pipe coupling according to a first embodiment of the invention in cross-section;

FIG. 2 shows a fuel pipe coupling according to a second embodiment of the invention in cross-section;

FIG. 3 shows a fuel pipe coupling according to a third embodiment of the invention in cross-section;

FIG. 4 shows a possible fuel pipe system arranged using two fuel pipe couplings according to the first embodiment of the invention; and

FIG. 5 shows a further possible fuel pipe system using two fuel pipe couplings according to a fourth embodiment of the invention.

### DETAILED DESCRIPTION OF THE DRAWINGS

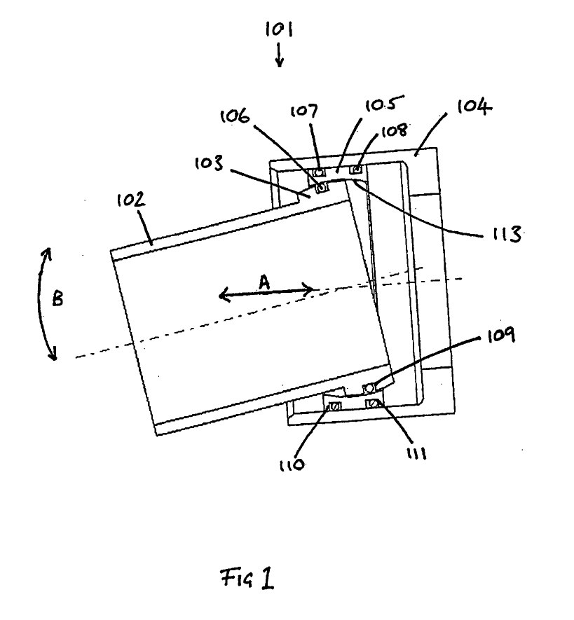

FIG. 1 shows a fuel pipe coupling 101 comprising a pipe end fitting 102 including a partially spherical flange 103 at the end of the pipe fitting 102, a socket arrangement 104, an elastomeric and resiliently deformable interfacing body 105 including a partially spherical internal surface 112, a first O-ring seal 106, a second O-ring seal 107 and a third O-ring seal 108. There is a first groove 109 in the partially spherical surface 103 of the pipe end fitting 102. There is a second and third groove, 110 and 111 respectively, in the external surface 113 of the resiliently deformable interfacing body 105. The partially spherical flange 103 of the pipe end fitting 102 is associated with the partially spherical internal surface 112 of the resiliently deformable interfacing body 105. The first O-ring seal 106 is located in the first groove 109 in the partially spherical flange 103 of the pipe end fitting 102. The first O-ring seal 109 provides a sealing contact between the partially spherical flange 103 of the pipe end fitting 102 and the partially spherical internal surface 112 of the resiliently deformable interfacing body 105. The association between the resiliently deformable interfacing body 105 and the partially spherical flange 103 of the pipe end fitting 102 is created by utilising the resiliently deformable characteristics of the interfacing body 105 and forcing the resiliently deformable interfacing body 105 over the partially spherical external surface 103 of the pipe end fitting. The resiliently deformable interfacing body 105 is located within the socket arrangement 104. The second O-ring seal 107 is located within the second groove 110 and the third O-ring seal 108 is located within the third groove 111 in the resiliently deformable interfacing body 105. The second O-ring seal 107 and third O-ring seal 108 provide a sealing contact between the resiliently deformable interfacing body 105 and the socket arrangement 104. The O-rings are made of typical materials, such as fluorinated silicone rubber. The resiliently deformable interfacing body 105 is preferably made of an elastomeric material, such as a fabric reinforced fluorinated silicone rubber or a suitable grade of PTFE, which is less deformable than the first seal 106, second seal 107 and third seal 108.

The fuel pipe coupling is designed for connecting fuel pipes that carry fuel around aircraft. In use, the pipe end fitting 102 may move both axially and angularly with respect to the socket arrangement, thereby compensating for any vibration or flexure of the part of the aircraft the fuel pipe coupling is located in. During axial movement the resiliently deformable interfacing body 105 moves back and forth within the socket arrangement 104. The socket arrangement 104 is 70 mm in diameter and 40 mm in depth, the depth being measured from the front of the internal surface of the socket arrangement to the back of the internal surface of the socket arrangement. The maximum amount of axial movement available is 18 mm. Arrow A shows the axial direction of displacement of the pipe end fitting. During angular movement, the partially spherical flange 103 of the pipe end fitting 102 rotates within the partially spherical internal surface 112 of the resiliently deformable interfacing body 105. The dimensions of the pipe end fitting 102 and the socket arrangement are such that there is a maximum allowable angular displacement of ±10 degrees of the pipe end fitting 102 within the socket arrangement 104. Arrow B shows a possible direction of angular displacement of the pipe end fitting.

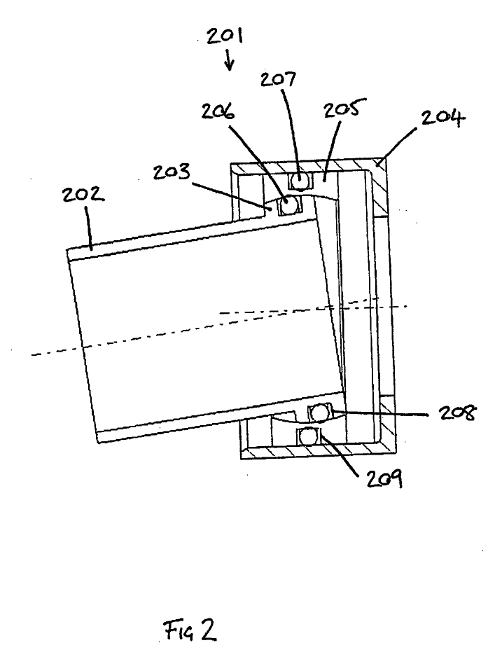

FIG. 2 shows a fuel pipe coupling 201 according to a second embodiment of the invention. The fuel pipe coupling 201 includes a pipe end fitting 202, a partially spherical flange 203, a socket arrangement 204, a resiliently deformable interfacing body 205, a first O-ring seal 206 and second O-ring seal 207, and corresponding first groove 208 and second groove 209 respectively. The arrangement of the second embodiment is substantially the same as that for the first embodiment, except for the fact that there are only two O-ring seals. In particular, only the second O-ring seal 207 is located between the resiliently deformable interfacing body 205 and the socket arrangement 204. In order that the overall seal strength of the fuel pipe coupling is of the same strength as when three seals are used in the first embodiment, the first O-ring seal 206 and second O-ring seal 207 are larger in cross sectional diameter than the first O-ring seal 106, second O-ring seal 107 and third O-ring seal 108.

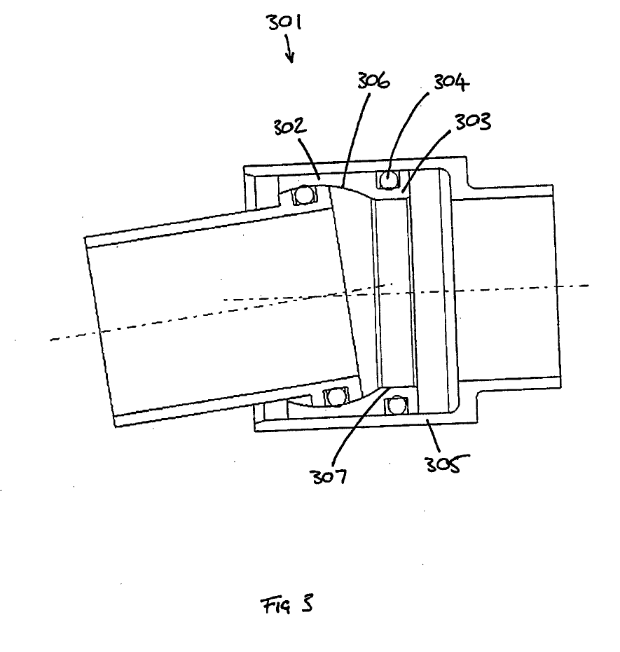

FIG. 3 shows a fuel pipe coupling 301 according to a third embodiment of the invention. The arrangement is substantially the same as for the first embodiment, though the resiliently deformable interfacing body includes a first section 302 with a partially spherical internal surface 306 and a second section 303 with a cylindrical internal surface 307, wherein the second section 303 includes the O-ring seal 304 which provides sealing contact between the resiliently deformable seal carrier and the socket arrangement 305. This embodiment has the advantage that the resiliently deformable interfacing body may be reduced in thickness, with the resultant overall reduction in width of the fuel pipe coupling. However, the coupling will also be longer as a result of the different seal arrangement to those shown in FIG. 1 and FIG. 2.

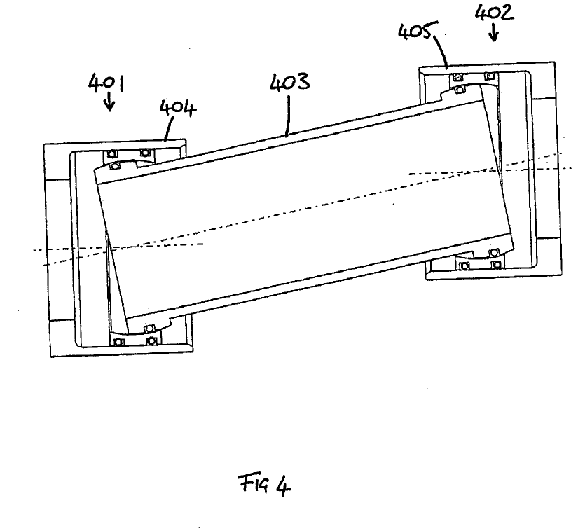

FIG. 4 shows a possible fuel pipe system comprising a first fuel pipe coupling 401 and a second fuel pipe coupling 402 both of which are as described in relation to FIG. 1 and the first embodiment of the invention and a fuel pipe 403 located between them. The first fuel pipe coupling 401 and the second fuel pipe coupling 402 each include a socket arrangement, 404 and 405 respectively, fixed to a respective rib connector in an aircraft wing. The fuel pipe 403 is trapped between the first fuel pipe coupling 401 and second fuel pipe coupling 402. While the fuel pipe 403 can move axially and angularly with respect to either or both of the fuel pipe couplings, in particular the socket arrangements of the fuel pipe couplings, the movement is restricted to such an extent that it may not become free from the couplings in normal use. In order to construct the arrangement as shown in FIG. 4 the first fuel pipe coupling 401 is connected to the relevant rib connector and the fuel pipe 403 inserted into the socket arrangement 404. The opposite end of the fuel pipe 403 is then inserted into the socket arrangement 405 of the second fuel pipe connector 402, the socket arrangement 405 then being connected to its relevant rib connector. Those of ordinary skill in the art will appreciate that any of the fuel pipe connectors described in the second or third embodiment would be suitable for use in such an assembly as that shown in FIG. 4.

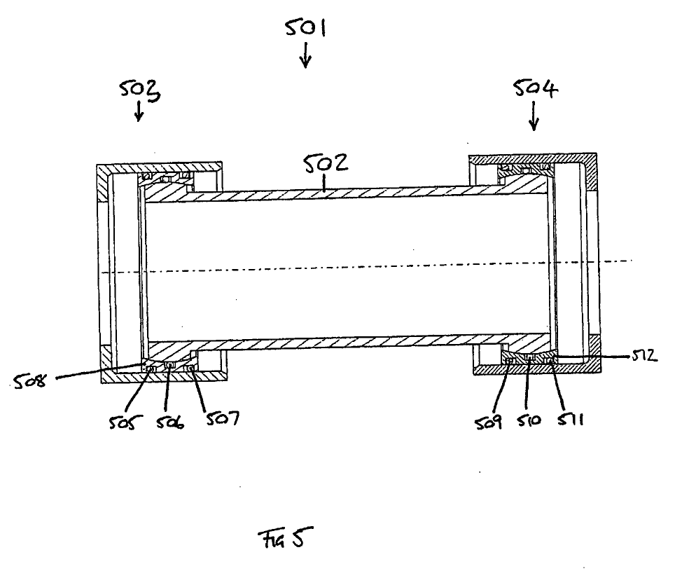

FIG. 5 shows a further possible fuel pipe system 501, which comprises a fuel pipe 502 and a first and second fuel pipe coupling, 503 and 504 respectively, according to a fourth embodiment of the invention. The arrangement of the couplings is substantially the same as for the others described above, however all of the seals, 505, 506, 507 and 509, 510, 511 are located within the respective resiliently deformable interfacing bodies, 508 and 512.

Whilst the present invention has been described and illustrated with reference to particular embodiments, it will be appreciated by those of ordinary skill in the art that the invention lends itself to many different variations not specifically illustrated herein.

The partially spherical flange of the pipe end fitting in any of the above described embodiments need not be partially spherical. The flange of the pipe end fitting need only be such that it is possible to create a sealing contact between the pipe end fitting and the resiliently deformable interfacing body, while allowing the pipe end fitting to move angularly relative to the socket arrangement. It is advantageous that the flange is partially spherical as it reduces the risk of seal or interfacing body extrusion at lower external pressures.

Furthermore, there may, for example, be variations in the numbers and/or positions of the O-ring seals forming a sealing arrangement with the resiliently deformable seal carrier. For example, the grooves in which the seals are located may be in the seal carrier, the partially spherical flange of the pipe end fitting or the socket arrangement. The resiliently deformable interfacing body may itself provide the seals, there being no separate O-ring seals.

The dimensions of the fuel pipe coupling may vary considerably, and are in part dependent on the dimensions of the fuel pipes that are being connected. The amount of angular movement allowed by the coupling may be greater or less than ±10 degrees. The amount of axial movement allowed by the coupling may be greater or less than 18 mm, it may be up to 50 mm or more, or may be as low as ±5 mm, or lower.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. An aircraft fuel pipe coupling comprising,
a pipe end fitting including a flange,
a socket arrangement in which the pipe end fitting is located,
a resiliently deformable interfacing body including a partially spherical internal surface,
the resiliently deformable interfacing body located between the pipe end fitting and the socket arrangement such that the partially spherical internal surface is associated with the flange of the pipe end fitting,
a first seal located between the partially spherical internal surface of the resiliently deformable interfacing body and the flange of the pipe end fitting, and
a second seal located between the resiliently deformable interfacing body and the socket arrangement.

2. An aircraft fuel pipe coupling as claimed in claim 1, wherein the resiliently deformable interfacing body is of one-piece construction.

3. An aircraft fuel pipe coupling as claimed in claim 1, wherein the flange of the pipe end fitting associated with the interfacing body is partially spherical.

4. An aircraft fuel pipe coupling as claimed in claim 1, wherein the pipe end fitting is capable of ±10 degrees of angular movement with respect to the socket arrangement.

5. An aircraft fuel pipe coupling as claimed in claim 1, wherein the pipe end fitting is capable of axial movement with relative to the socket arrangement.

6. An aircraft fuel pipe coupling as claimed in claim 1, wherein the pipe end fitting is capable of up to 50 mm axial movement relative to the socket arrangement.

7. An aircraft fuel pipe coupling as claimed in claim 1, wherein the resiliently deformable interfacing body comprises a material less deformable than the first seal.

8. An aircraft fuel pipe coupling as claimed in claim 1, wherein the resiliently deformable interfacing body carries at least one seal.

9. An aircraft fuel pipe coupling as claimed in claim 1, wherein the resiliently deformable interfacing body carries at least two seals.

10. An aircraft fuel pipe coupling as claimed in claim 1, wherein the resiliently deformable interfacing body carries no seals.

11. An aircraft fuel pipe coupling as claimed in claim 1, wherein at least one of the seals is carried in a Gamah profile seal carrier.

12. An aircraft fuel pipe system, including a first and second aircraft fuel pipe coupling as claimed in claim 1, wherein the first and second pipe end fittings form the opposite ends of a fuel pipe, the fuel pipe extending between the first socket arrangement and second socket arrangement.

13. An aircraft fuel pipe system as claimed in claim 12, wherein the fuel pipe is fully floating between the first socket arrangement and second socket arrangement.

14. An aircraft fuel pipe system, including a first aircraft fuel pipe coupling, as claimed in claim 1, further including a first fuel pipe connected to the pipe end fitting and a second fuel pipe connected to the socket arrangement.

15. A method of connecting aircraft fuel pipes, the method comprising the steps of:
providing a pipe end fitting including a flange,
providing a deformable interfacing body including a partially spherical internal surface,
manipulating the resiliently deformable interfacing body over the pipe end fitting such that the partially spherical internal surface is associated with the flange of the pipe end fitting and such that a seal is formed between the flange of the pipe end fitting and the resiliently deformable interfacing body,
providing a socket arrangement, and
locating the pipe end fitting and resiliently deformable interfacing body in the socket arrangement such that a seal is formed between the resiliently deformable interfacing body and the socket arrangement.

16. A method of connecting aircraft fuel pipes as claimed in claim 15, wherein the flange of the pipe end fitting is partially spherical.

17. A method of connecting aircraft fuel pipe as claimed in claim 15 further including the step of transferring fuel through the fuel pipes.

18. A method of connecting aircraft fuel pipe as claimed in claims 15, the method further including a step, which is performed after the pipe end fitting and the resiliently deformable interfacing body are located in the socket arrangement, of effecting relative movement between the pipe end fitting and the socket arrangement of a distance of more than 9 mm as measured along the axis of the pipe end fitting.

19. A method of connecting aircraft fuel pipe as claimed in claim 15, the method further including a step, which is performed after the pipe end fitting and the resiliently deformable interfacing body are located in the socket arrangement, of effecting relative rotational movement between the pipe end fitting and the socket arrangement of a distance of more than 5 degrees about an axis transverse to the axis of the pipe end fitting.

20. An aircraft including a fuel pipe coupling according to claim 1.

21. A kit of parts comprising a pipe end fitting, a socket arrangement, a resiliently deformable interfacing body, suitable for arrangement into a fuel pipe coupling as claimed in claim 1.
